(19) United States
(12) Patent Application Publication
(10) Pub. No.: US 2011/0063060 A1
(43) Pub. Date: Mar. 17, 2011

(54) MAGNETIC APPARATUS AND MAGNETIC SYSTEM FOR OUTPUTTING POWER

(76) Inventors: Shao Hsiung CHANG, Taoyuan Hsien (TW); Chii How Chang, Taoyuan Hsien (TW)

(21) Appl. No.: 12/884,896

(22) Filed: Sep. 17, 2010

Related U.S. Application Data
(60) Provisional application No. 61/243,352, filed on Sep. 17, 2009.

(51) Int. Cl. H01F 7/02

(52) U.S. Cl. 335/306

(57) ABSTRACT

A magnetic apparatus and a magnetic system are provided. The magnetic apparatus or the magnetic system includes the magnetic apparatus that can generate the mechanical torque and at least two magnetic apparatus are coupled together to sum each mechanical torque. In addition, a phase angle delay of each of the magnetic torque of the at least two magnetic apparatus is arranged to minimize a torque ripple so as to output a power smoothly. Therefore, a better working condition of the magnetic apparatus and the whole magnetic system can be selected for demonstrating a better performance. Furthermore, a permanent magnetic element of the magnetic apparatus can rotate more smoothly.

### CROSS REFERENCE TO RELATED APPLICATIONS

This application claims the benefit of U.S. Provisional Application No. 61/243,352, filed Sep. 17, 2009, the entirety of which is incorporated by reference herein.

### BACKGROUND OF THE INVENTION

1. Field of the Invention

The invention relates to a magnetic apparatus and a magnetic system including the magnetic apparatus and, in particular, to a magnetic apparatus and a magnetic system including the magnetic apparatus which can generate the mechanical torque and at least two magnetic apparatus are coupled together to sum each mechanical torque. In addition, a phase angle delay of each of the magnetic torque of the at least two magnetic apparatus is arranged to minimize a torque ripple so as to output a smooth power.

2. Description of the Related Art

There are many ways to produce renewable power such as using solar panel to collect the sunlight and convert the sunlight into power. The conventional magneto caloric effect (MCE) principle is well-known to be applied to manufacture the magnetic refrigerator which is described in the published paper “Performance of a room-temperature rotary magnetic refrigerator”, International Journal of Refrigeration 29 (2006) 1327-1331. For the magnetic cooling application, the magnetic field is chosen to change the magnetic phase of the magneto caloric effect material (MCEM) so as to cause the change of magnetic entropy of the MCEM. Therefore, the temperature of the MCEM will also be changed. The larger the magnetic moment changes, the larger cooling capacity will be achieved.

As shown in FIG. 1a and FIG. 1b, a conventional magnetic refrigerator 1 mainly includes a motor 124, a pump 108, a rotary value 104, a permanent magnet 120, an iron yoke 126, and four active magnetic regeneration (AMR) beds 122a, 122b, 122c, and 122d. Each AMR bed which is one kind of MCEM is composed of Gd-based alloy spheres. The motor 124 rotates with the permanent 120. The magnetic phase of the AMR bed changes so as to result the change of magnetic entropy of the AMR bed. Therefore, the temperature of the AMR bed will also change. The pump 108 circulates the heat transfer fluid (water) and the rotary valve 104 switches the flow lines. Initially, the water is cooled as it is pumped from the hot end to the cold end of the demagnetized beds. Subsequently, the water picks up a thermal load as it passes through the cold stage, and then absorbs heat as it travels from the cold end to the hot end of the magnetized beds. The heat is given up as the water passes through the exhaust-side heat exchanger 112.

FIG. 2 shows relationship curves of the magnetic field versus the magnetized scale of the Gadolinium which is one kind of magneto caloric effect material (MCEM), and the curves also show the magnetization of Gadolinium is dependent to the temperature. For the environmental protection, other method to acquire the renewable energy is necessary. The MCEM is not only suitable for the magnetic refrigeration but also for the heat-power conversion application to output the power.

### BRIEF SUMMARY OF THE INVENTION

A detailed description is given in the following embodiments with reference to the accompanying drawings.

In one aspect of the present invention is to provide a magnetic apparatus and a magnetic system including the magnetic apparatus that can generate the mechanical torque and at least two magnetic apparatus are coupled together to sum each mechanical torque. In addition, a phase angle delay of each of the magnetic torque of the at least two magnetic apparatus is arranged to minimize a torque ripple so as to output a smooth power. Therefore, a better working condition of the magnetic device and the whole magnetic system can be selected for demonstrating a better performance.

To achieve the above, another aspect of the present invention discloses a magnetic apparatus for smooth power output. The magnetic apparatus includes a magnetic material, at least one heated or cooled magneto caloric effect material (MCEM), a permanent magnetic element, and at least one amount of magnetic flux or magnetic flux path. The heated or cooled magneto caloric effect material (MCEM) is disposed to the magnetic material. The permanent magnetic element is coupled to the magneto caloric effect material (MCEM). The major amount of magnetic flux or major magnetic flux path is formed and passing through the permanent magnetic element, the cooled magneto caloric effect material (MCEM), and the first portion of the magnetic material. In addition, the permanent magnetic element of the magnetic apparatus or the magnetic material of the magnetic apparatus rotates by heating or cooling the heated or cooled magneto caloric effect material, a mechanical torque is generated by the magnetic apparatus and at least two magnetic apparatus are coupled together to sum each mechanical torque.

In another aspect of the invention also discloses a magnetic system for smooth power output further includes at least one thermal energy switching unit and a magnetic apparatus. The magnetic apparatus has a magnetic material, at least one heated or cooled magneto caloric effect material, a permanent magnetic element, and at least one amount of magnetic flux or magnetic flux path. The heated or cooled magneto caloric effect material is disposed to the magnetic material and connected to the thermal energy switching unit. The permanent magnetic element is coupled to the magneto caloric effect material, and at least one amount of magnetic flux or magnetic flux path is formed and passing through the permanent magnetic element, the cooled magneto caloric effect material, and the magnetic material. In addition, the permanent magnetic element of the magnetic apparatus or the magnetic material of the magnetic apparatus rotates by controlling the thermal energy switching unit to heat or cool the heated or cooled magneto caloric effect material, a mechanical torque is generated by the magnetic apparatus and at least two magnetic apparatus are coupled together to sum each mechanical torque. Furthermore, a phase angle delay of each of the magnetic torque of the at least two magnetic apparatus is arranged to minimize a torque ripple so as to output a smooth power.

Therefore, the permanent magnetic element can rotate more smoothly to save more mechanical energy which can be turned into more power. In this way, a better working condition of the magnetic device and the whole magnetic system can be selected for demonstrating a better performance.

### BRIEF DESCRIPTION OF THE DRAWINGS

The present invention can be more fully understood by reading the subsequent detailed description and examples with references made to the accompanying drawings, wherein:

FIG. 1a is a schematic diagram of a conventional magnetic refrigerator;

FIG. 1b is a cross sectional view of the conventional magnetic refrigerator;

FIG. 2 shows relationship curves of the magnetic field versus the magnetized scale of the Gadolinium;

FIG. 3a is a schematic diagram showing a top view of a heat-power conversion magnetic device and two main magnetic flux paths when the hot thermal energy is applied to the MCEM 304a and the cold thermal energy is applied to the MCEM 304b and MCEM 304c;

FIG. 3b is a schematic diagram showing a top view of a heat-power conversion magnetic apparatus and two main magnetic flux paths when the hot thermal energy is applied to the MCEM 304b and the cold thermal energy is applied to the MCEM 304c and MCEM 304a;

FIG. 3c is a schematic diagram showing a top view of a magnetic apparatus with two main magnetic flux paths when the hot thermal energy is applied to the MCEM 304a and the cold thermal energy is applied to the MCEM 304b and MCEM 304c;

FIG. 3d is a schematic diagram showing a heat-power conversion magnetic apparatus with the magnetic material of the magnetic apparatus rotating by heating or cooling the heated or cooled magneto caloric effect material disposed to the magnetic material so as to generate a mechanical torque;

FIG. 4a is a side schematic view of a magnetic force generating device with a single-layer MCEM;

FIG. 4b is a side schematic view of a magnetic force generating device with a multiple-layers MCEM;

FIG. 4c shows relationship curves of the multiple-layers MCEM structure of FIG. 4b versus the temperature, and it also shows the Curie temperature of each layer of the multiple-layers MCEM structure;

FIG. 5a is a schematic diagram showing a top view of a magnetic apparatus with a magnetic material, six MCEMs, and a permanent magnetic element with a yoke and four poles;

FIG. 5b is a table showing the sequence of heating and cooling the six MCEMs so as to control the rotating direction of the permanent magnetic element as shown in FIG. 5a;

FIGS. 6a, 6b, and 6c are the temperature-versus-step diagram showing when to heat and cool the six MCEMs;

FIG. 7a is a torque-versus-step diagram showing a magnetic torque waveform generated by only one magnetic apparatus; and

FIG. 7b is a torque-versus-step diagrams showing three torque waveforms, there is a phase angle delay in the below two magnetic torque waveforms, and the above magnetic torque waveform is generated by summing the below two magnetic torque waveforms so as to reduce the magnetic torque ripple.

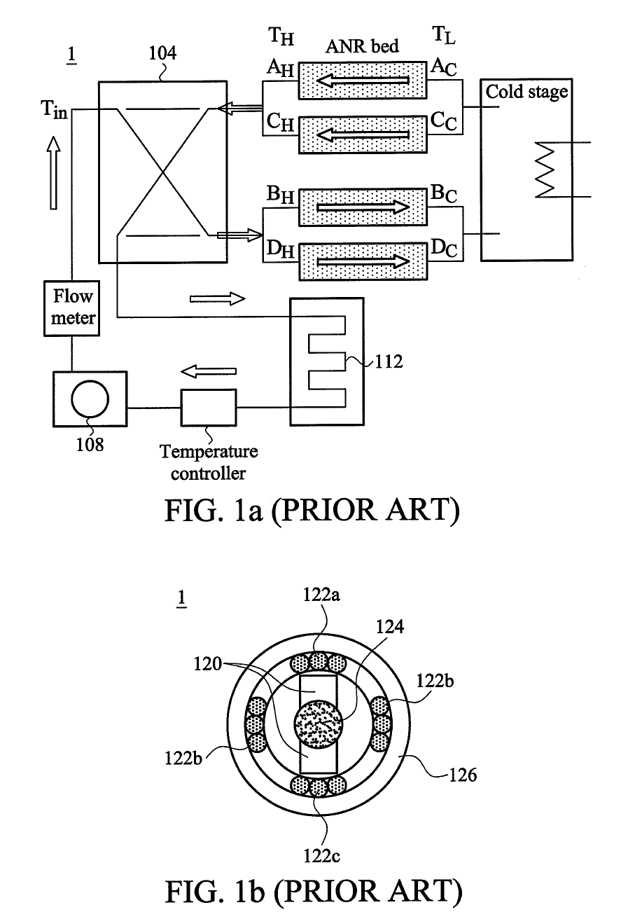

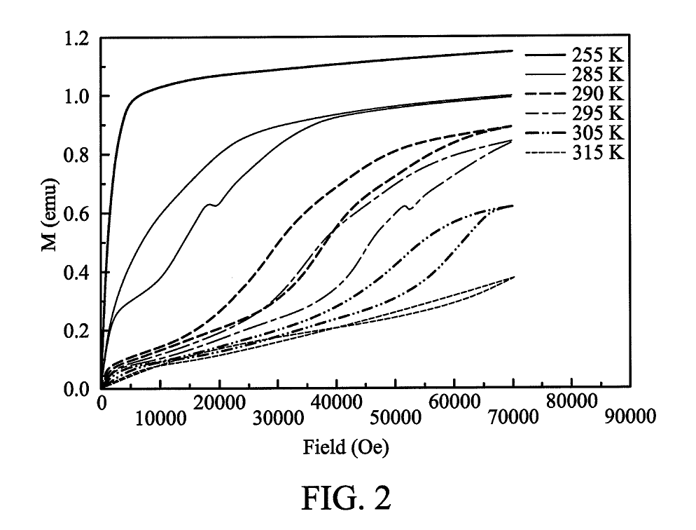

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The magneto caloric effect material (MCEM) is not only suitable for the magnetic refrigeration but also for the heat-power conversion application. It is an important subject to provide an acquiring renewable energy system (which is also a magnetic system in this invention) and a magnetic apparatus so as to apply the reduced magnetic torque into the magnetic system to output power efficiently. In addition, different kinds of magneto caloric effect material (MCEM) have their own Curie temperature (Tc). The magneto caloric effect material (MCEM) usually has the dramatically magnetic moment change when the temperature of the materials is changed around its Curie temperature (Tc). Such kinds of materials are perfectly suitable for heat to power conversion.

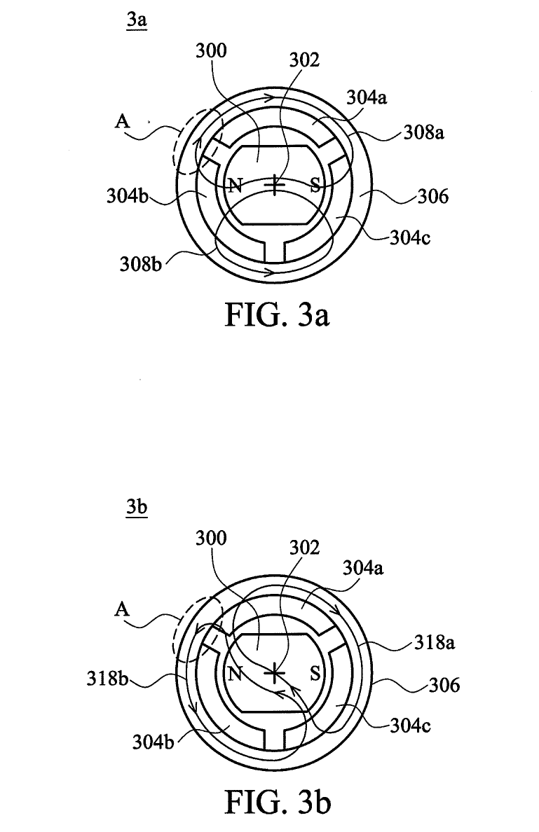

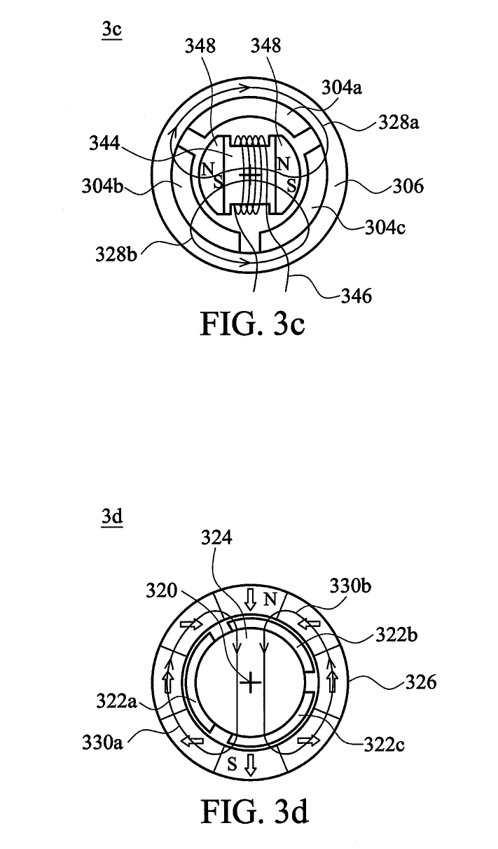

As shown in FIG. 3a, a (heat-power conversion) magnetic apparatus 3a includes a magnetic material 306, a rotation axis 302, three magneto caloric effect materials (MCEMs) 304a, 304b, and 304c, and a permanent magnetic element 300 such as a permanent magnet or a Halbach-array magnet. The three magneto caloric effect materials (MCEMs) 304a, 304b, and 304c are disposed to the magnetic material 306. The permanent magnetic element 300 is coupled to the magneto caloric effect materials (MCEMs) 304a, 304b, and 304c. Two major magnetic flux paths 308a, 308b are formed when the hot thermal energy is applied to the magneto caloric effect material (MCEM) 304a and the cold thermal energy is applied to the magneto caloric effect material (MCEM) 304b and magneto caloric effect material (MCEM) 304c The magnetic material 306 can be a high permeability magnetic material or a yoke. In addition, the magnetic material 306 is formed a circle-shaped structure in the FIG. 3a. However, the magnetic material 306 can also be formed as an oval-shaped structure, a rectangular-shaped structure, an annular-shaped structure, or a polygonal-shaped structure. When the hot thermal energy is applied to magneto caloric effect material (MCEM) 304a, the magnetic moment of magneto caloric effect material (MCEM) 304a is changed to low magnetic moment state. In addition, when the cold thermal energy is applied to magneto caloric effect material (MCEM) 304b and 304c, the magnetic moment of magneto caloric effect material (MCEM) 304b and 304c are changed to high state. Furthermore, the heated or cooled magneto caloric effect material is attached along with the magnetic material, and the permanent magnetic element is disposed in the magnetic material. The permanent magnetic element 300 has two magnetic poles, and the magnetic apparatus 3a has three heated or cooled magneto caloric effect materials 304a, 304b and 304c. In addition, the permanent magnetic element 300 can also have two magnetic poles, and the magnetic apparatus 3a can have six heated or cooled magneto caloric effect materials (not shown in the figures). One major magnetic flux 308b generated by the permanent magnetic element 300 flows through magneto caloric effect material (MCEM) 304b, magnetic material 306 and magneto caloric effect material (MCEM) 304c then returns to the permanent magnetic element 300. The permanent magnetic element 300 is a permanent magnet, a permanent magnet array, or a Halbach magnet. The other major magnetic flux 308a generated by the permanent magnetic element 300 flows through magneto caloric effect material (MCEM) 304b, high permeability magnetic material 306 and magneto caloric effect material (MCEM) 304c then return to the permanent magnetic element 300. The (heat-power conversion) magnetic apparatus 3a now is in its static state and maintains the permanent magnetic element 300 in horizontal position with the lowest magnetic resistance.

As shown in FIG. 3b, the structure of the (heat-power conversion) magnetic apparatus 3b is the same with the (heat-power conversion) magnetic apparatus 3a. When the hot thermal energy is applied to the magneto caloric effect material (MCEM) 304b and cold thermal energy is applied to magneto caloric effect material (MCEM) 304a and magneto caloric effect material (MCEM) 304c, the magnetic moment of magneto caloric effect material (MCEM) 304b is at low level state and magnetic moment of the magneto caloric effect material (MCEM) 304a and 304c are at high level state. The magnetic pole N of the permanent magnetic element 300 will be attracted by magneto caloric effect material (MCEM) 304a and magnetic pole S of the permanent magnetic element 300 will be attracted by magneto caloric effect material (MCEM) 304c. Therefore, the permanent magnetic element 300 will rotate and the mechanical torque is generated through the rotation axis 302. If it continuously changes the heating and cooling sequence of magneto caloric effect material (MCEM) 304a, 304b and 304c, it will produce continuous mechanical torque and the mechanical torque can be converted into power. However, the mechanical torque has greater torque ripple, and it causes the output power generated ruggedly. At least two other magnetic apparatus can be coupled together to sum each mechanical torque and a phase angle delay of each of the magnetic torque of the at least two magnetic apparatus 3a is arranged to minimize a torque ripple so as to output a smooth power. The phase delay is determined according to the number of the magnetic apparatus. In this embodiment, the number of the magnetic apparatus is 3, thus the phase delay is 120 degree. Usually, the magnetic apparatus 3a converts a low grade of heat into a mechanical power, and the low grade of heat is below 100 degree of Centigrade. In addition, the magnetic apparatus 3a has the mechanical torque thus generating a mechanical power is connected to drive an electrical generator for generating electrical power.

Moreover, the magnetic apparatus 3a further includes a magnetic force generating device (not shown in the figure) disposed to heat or cool the heated or cooled magneto caloric effect material 304a, 304b, 304c. The magnetic force generating device is designed to store sensible heat released during a cooling process and release sensible heat during a heating process. The thermal energy is generated during the cooling process and the heating process and is transferred to the magnetic force generating device. In the other way, the thermal energy is transferred from the magnetic force generating device to the heated or cooled magneto caloric effect material 304a, 304b, 304c. Therefore, the magnetic apparatus 3a can utilize the thermal energy more efficiency.

The portion “A” in FIG. 3a and FIG. 3b indicates the flowing direction of magnetic flux. The major amount of magnetic flux flows in clockwise (CW) direction when the magneto caloric effect material (MCEM) 304a is heated (FIG. 3a) and the other major magnetic flux flows in counterclockwise (CCW) direction when the magneto caloric effect material (MCEM) 304b is heated (FIG. 3b). It is obviously, heating and cooling the magneto caloric effect materials (MCEMs) 304a, 304b, and 304c will change the magnetic moment of the magneto caloric effect materials (MCEMs) 304a, 304b, and 304c so as to induce the change of the amount of the magnetic flux. The magnetic apparatus 3a is provided according to a first preferred embodiment of the invention.

As shown in FIG. 3c, a magnetic apparatus 3c is provided as the second preferred magnetic apparatus embodiment of the invention. The magnetic apparatus 3c includes a magnetic material 306, at least one heated or cooled magneto caloric effect material (MCEM) 304a, 304b, 304c, and the permanent magnetic element 340, and at least one amount of magnetic flux or magnetic flux path 328a, 328b. The permanent magnetic element 340 generating at least two magnetic poles includes a first magnet 342, a first magnetic material 344, an exciting coil 346, and a second magnet 348. The first magnetic material 344 is disposed with the first magnet 342. The exciting coil 346 surrounding the first magnetic material 344 is input with an exciting control signal. The second magnet 348 is disposed with the first magnetic material 344. The first magnetic material 344 can also be a yoke and the exciting coil 346 is a superconductor coil.

In addition, the exciting coil 346 can be an electrical conductive coil or a superconductor coil, and the magnetic flux paths or the amounts of the magnetic flux 328a, 328b are changed after the exciting control signal is input to the exciting coil 346. An exciting coil 346 is introduced and a sine wave voltage is applied to the exiting coil 346. The applying sine wave voltage will influence the amount of the magnetic flux provided by the magnetic poles (N pole and S pole) of the first magnet 342 and the magnetic poles (N pole and S pole) of the second magnet 348. Therefore, a magnetic flux with small amount of variation is generated. The flux variation frequency and the voltage frequency applied to exciting coil 346 are same frequency.

As shown in FIG. 3d, magnetic apparatus 3d for smooth power output includes a magnetic material 324, at least one heated or cooled magneto caloric effect material 322a, 322b, or 322c, a permanent magnetic element 326, and at least one amount of magnetic flux or magnetic flux path 330a, 330b. The heated or cooled magneto caloric effect material 322a, 322b, or 322c is disposed to the magnetic material 324. The permanent magnetic element 326 is coupled to the magneto caloric effect material 322a, 322b, or 322c. The permanent magnetic element 326 can be a permanent magnet or a Halbach-array magnet. The amount of magnetic flux or magnetic flux path 330a, 330b is formed and passing through the permanent magnetic element 326, the cooled magneto caloric effect material 322b, 322c, and the magnetic material 324. The magnetic material 324 of the magnetic apparatus 3d in the permanent magnetic element 326 rotates by heating or cooling the heated or cooled magneto caloric effect material 322a, 322b, and 322c, a mechanical torque is generated by the magnetic apparatus 3d and at least two other magnetic apparatus are coupled together to sum each mechanical torque. In addition, a phase angle delay of each of the magnetic torque of the at least two magnetic apparatus is arranged to minimize a torque ripple so as to output a smooth power. The magnetic apparatus 3d is provided according to a third preferred embodiment of the invention.

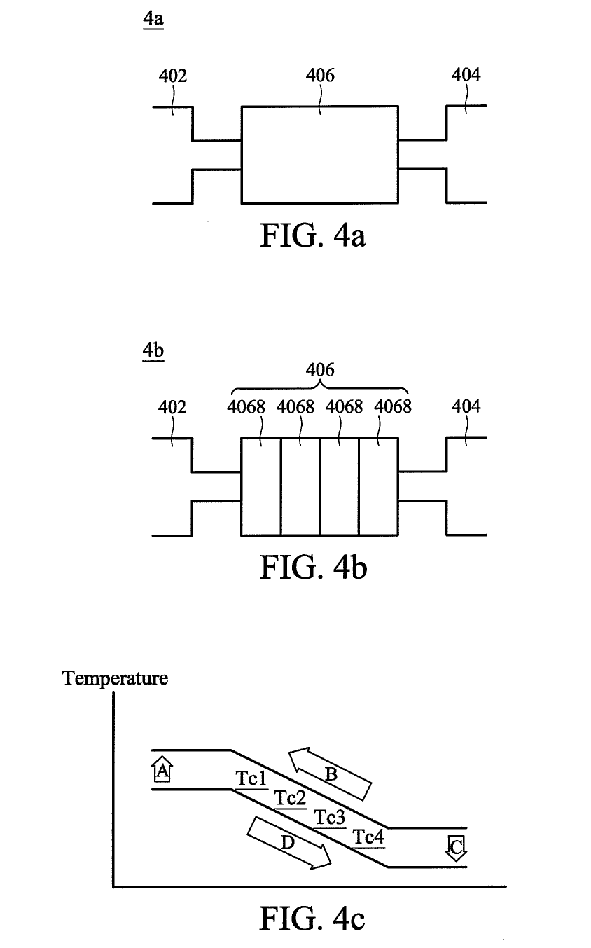

As shown in FIG. 4a, a side schematic view of a magnetic force generating device 4a with a single-layer magneto caloric effect material (MCEM) is demonstrated. The magnetic force generating device 4a includes the hot side chamber 402, the cool side chamber 404 and the single-layer magneto caloric effect material (MCEM) 406. The magnetic force generating device 4a utilizes the magneto-caloric-effect properties of certain materials, such as Gadolinium or certain alloys and forms a single-layer magneto caloric effect material (MCEM) 406. The magnetic force generating device 4a also has the particularity of magnetizing when a cool fluid is filled in the cool side chamber 404 so as to cool the single-layer magneto caloric effect material (MCEM) 406. Therefore, the amount of the magnetic flux or the magnetic flux path can be formed from the permanent magnetic element to the single-layer magneto caloric effect material (MCEM) 406. On the contrary, the magnetic force generating device 4a has the particularity of demagnetizing when a heated fluid is filled in the hot side chamber 402 so as to heat up the single-layer magneto caloric effect material (MCEM) 406. Therefore, the amount of magnetic flux or the magnetic flux path can not be formed from the permanent magnetic element to the single-layer magneto caloric effect material (MCEM) 406. In addition, the heated or cooled magneto caloric effect material (MCEM) 406 is a single-layer magneto caloric effect material (MCEM) with a single curie temperature.

As shown in FIG. 4b and FIG. 4c, a side schematic view of a magnetic force generating device 4b with a multiple-layer magneto caloric effect material (MCEM) 406 is demonstrated. The magnetic force generating device 4b includes the hot side chamber 402, the cool side chamber 404 and the multiple-layer magneto caloric effect material (MCEM) 406 (four-layer MCEM) with a plurality of Curie temperatures (four curie temperature). Each layer of the multiple-layer magneto caloric effect material (MCEM) 406 has its own Curie temperature. For example, the layer 4062 has the Curie temperature Tc1, the layer 4064 has the Curie temperature Tc2, the layer 4066 has the Curie temperature Tc3, and the layer 4068 has the Curie temperature Tc4. The way to heat or cool the magnetic force generating device 4b is the same as described in the above paragraph. Therefore, it is not described here again. Each layer of the multiple-layers magneto caloric effect material (MCEM) 406 is disposed sequentially according to the single curie temperature of each layer of the multiple-layers magneto caloric effect material (MCEM) 406 (Tc1>Tc2>Tc3>Tc4). Pushing the working fluid of hot side chamber 402 and cool side chamber 404 back and forth, a temperature gradient is generated in the flow direction as shown in FIG. 4c. When the working fluid is pushed from hot side chamber 402 to cool side chamber 404, the temperature of each layer of the multiple-layers magneto caloric effect material (MCEM) 406 is higher than its Curie temperature. When the working fluid is pushed from cool side chamber 404 to hot side chamber 402, the temperature of each layer of the multiple-layers magneto caloric effect material (MCEM) 406 is lower than its Curie temperature. The arrows A, B, C, and D represent the four processes of FIG. 4c and the arrows show the change of temperature. Back to the FIG. 3a-3d, the magneto caloric effect materials (MCEMs) 304a, 304b, 304c, 322a, 322b, and 322c can be a single-layer magneto caloric effect material (MCEM) having a single curie temperature or a multiple-layers magneto caloric effect material (MCEMs) having a plurality of curie temperatures.

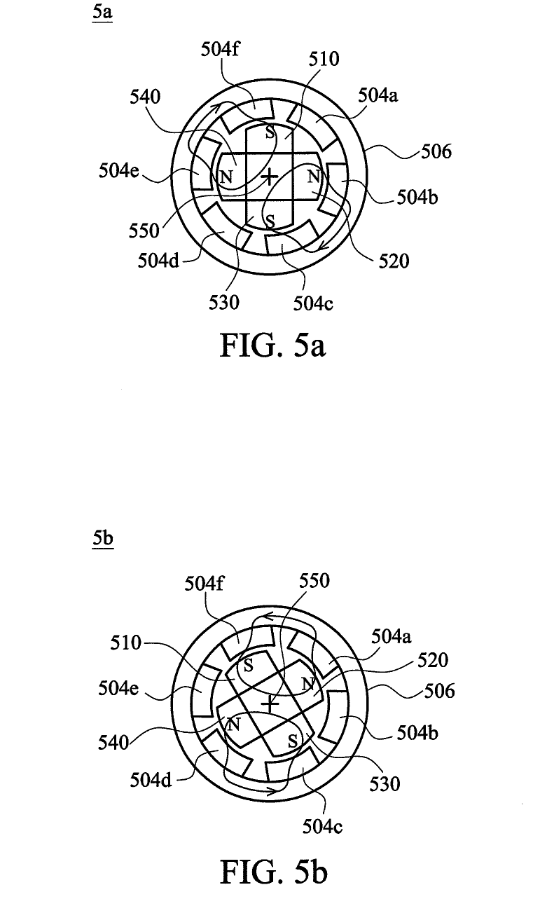

Please refer to FIG. 5a and FIG. 5b. FIG. 5a is a schematic diagram showing a top view of a magnetic apparatus 5a with a magnetic material 506, six magneto caloric effect materials (MCEMs) 504a, 504b, 504c, 504d, 504e, and 504f, and a permanent magnetic element 500 including a yoke 550 and four magnetic poles 510, 520, 530, 540 according to a fourth preferred embodiment of the invention.

FIG. 5b is a table showing the sequence of heating and cooling the six magneto caloric effect materials (MCEMs) so as to control the rotating direction of the permanent magnetic element 500 as shown in FIG. 5a. By changing the sequence of heating and cooling of the six magneto caloric effect materials (MCEMs) according to the table, it can control the rotation direction of the permanent magnetic element 500 by fixing the rotation axis 502 of the permanent magnetic element 500 in counterclockwise direction or clockwise direction. At least two magnetic apparatus 5a can be coupled together to sum each mechanical torque and a phase angle delay of each of the magnetic torque of the at least two magnetic apparatus 5a is arranged to minimize a torque ripple so as to output a smooth power. The other characteristic of the magnetic apparatus 5a is similar to the magnetic apparatus 3a as described in the above paragraph, therefore, it is omitted here.

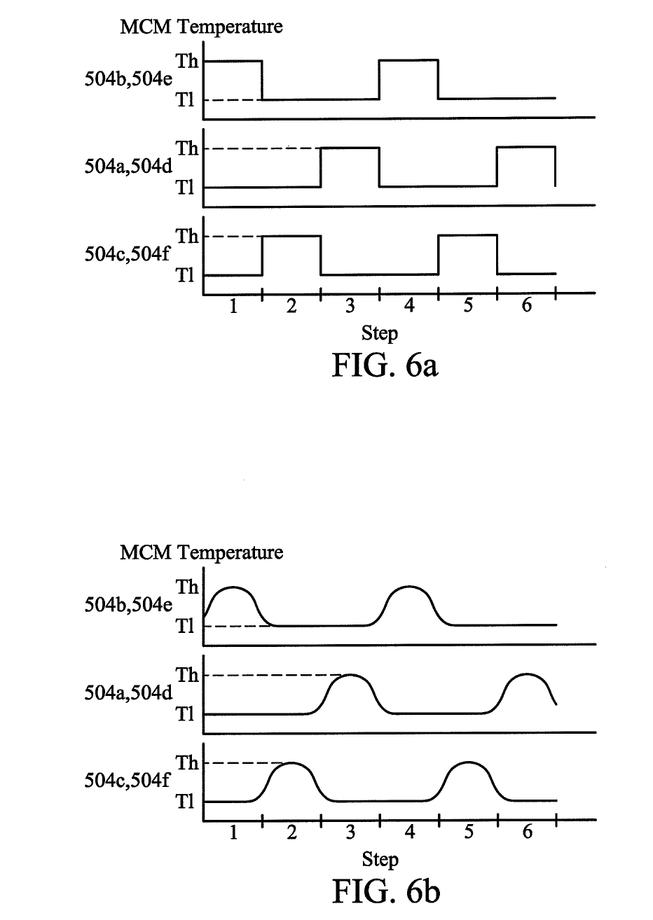

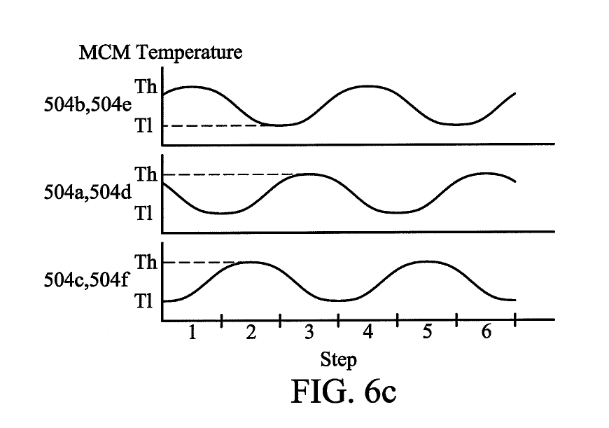

FIGS. 6a, 6b, and 6c are the temperature-versus-step diagrams showing when to heat and cool six magneto caloric effect materials (MCEMs). To be understood, the heating and cooling waveform can be any kind of waveform, not to limit in this embodiment. The proper waveform of temperature waveform is chosen base on the torque output for different kinds of applications. For example, the temperature waveform shown in FIG. 6a can deliver the maximum power and the temperature waveform shown in FIG. 6b can deliver the smoother power output. If much smoother torque output is required, the temperature waveform shown in FIG. 6c is preferred.

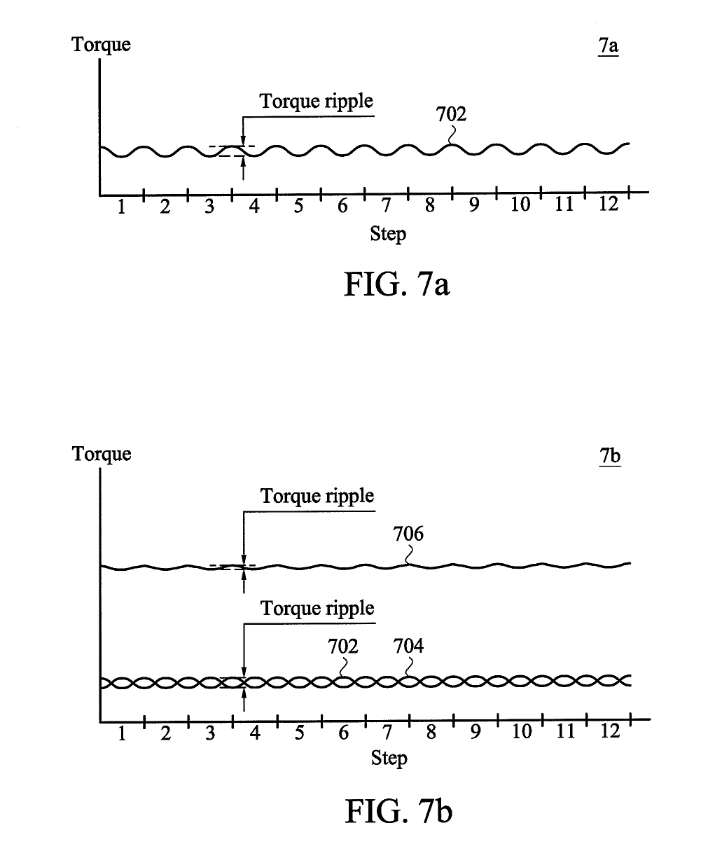

As shown in FIG. 7a, a torque-versus-step diagram showing a magnetic torque waveform 702 generated by magnetic apparatus 3a, 3b, 3c, 3d or 5a. A large magnetic torque ripple is demonstrated in FIG. 7a. It causes the inner rotor (such as permanent magnetic element 300) of the magnetic apparatus 3a rotate ruggedly; therefore, the output power is generated suddenly and stops being generated then. The situation may cause damage to the magnetic apparatus 3a, 3b, 3c, 3d or 5a.

As shown in FIG. 7b, a torque-versus-step diagrams showing three torque waveforms, there is a phase angle delay in the below two magnetic torque waveforms 702 and 704 generated respectively by two magnetic apparatus. The phase angle delay is:

$$\frac{a circle angle ( 360 ° )}{an amount of the magnetic apparatus}$$

The circle angle (360 degrees) is a whole step angle (360 degrees). Therefore, there are 12 steps in FIG. 7b and each of the steps is 300. The above magnetic torque waveform 706 is generated by summing the below two magnetic torque waveforms 702 and 704 so as to reduce the magnetic torque ripple. Therefore, a smoother power can be output. In addition, each of magnetic apparatus 3a, 3b, 3c, 3d or 5a has the same amount of the heated or cooled magneto caloric effect material, and the permanent magnetic element so as to achieve a lower torque ripple and output a smoother power by connecting the two magnetic apparatus. Besides, each of magnetic apparatus 3a, 3b, 3c, 3d or 5a has the same amount of the heated or cooled magneto caloric effect material and the permanent magnetic element, and the permanent magnetic element generates two magnetic poles.

A magnetic system for smooth power output further includes at least one thermal energy switching unit and a magnetic apparatus (not shown in the figures). The magnetic apparatus has a magnetic material, at least one heated or cooled magneto caloric effect material, a permanent magnetic element, and at least one amount of magnetic flux or magnetic flux path. The heated or cooled magneto caloric effect material is disposed to the magnetic material and connected to the thermal energy switching unit. The permanent magnetic element is coupled to the magneto caloric effect material, and at least one amount of magnetic flux or magnetic flux path is formed and passing through the permanent magnetic element, the cooled magneto caloric effect material, and the magnetic material. In addition, the permanent magnetic element of the magnetic apparatus or the magnetic material of the magnetic apparatus rotates by controlling the thermal energy switching unit to heat or cool the heated or cooled magneto caloric effect material, a mechanical torque is generated by the magnetic apparatus and at least two magnetic apparatus are coupled together to sum each mechanical torque. Furthermore, a phase angle delay of each of the magnetic torque of the at least two magnetic apparatus is arranged to minimize a torque ripple so as to output a smooth power. The characteristic of the magnetic apparatus of the magnetic system is similar to the magnetic apparatus 3a as described in the above paragraph; therefore, it is omitted here.

In summary, the invention is to provide a magnetic apparatus and a magnetic system including the magnetic apparatus that can generate the mechanical torque and at least two magnetic apparatus are coupled together to sum each mechanical torque. In addition, a phase angle delay of each of the magnetic torque of the at least two magnetic apparatus is arranged to minimize a torque ripple so as to output a smooth power. Therefore, a better working condition of the magnetic device and the whole magnetic system can be selected for demonstrating a better performance.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A magnetic apparatus for outputting power, comprising:
a magnetic material;
at least one heated or cooled magneto caloric effect material disposed to the magnetic material;
a permanent magnetic element coupled to the magneto caloric effect material; and
at least a part of magnetic flux or magnetic flux paths formed to pass through the permanent magnetic element, the magneto caloric effect material, and the magnetic material;
wherein the permanent magnetic element or the magnetic material of the magnetic apparatus rotates when heating or cooling the heated or cooled magneto caloric effect material, a mechanical torque is generated by the magnetic apparatus; and
wherein at least two magnetic apparatus are coupled together to sum each mechanical torque.

2. The magnetic apparatus as recited in claim 1, wherein a phase angle delay of each of the mechanical torque of the at least two magnetic apparatus is arranged to minimize a torque ripple, and the phase angle delay is:
$$\frac{a circle angle ( 360 ° )}{an amount of the magnetic apparatus}$$

3. The magnetic apparatus as recited in claim 2, wherein the circle angle is a whole step angle.

4. The magnetic apparatus as recited in claim 1, wherein the magnetic material is a high permeability magnetic material or a yoke.

5. The magnetic apparatus as recited in claim 1, wherein the heated or cooled magneto caloric effect material is a single-layer magneto caloric effect material with a single curie temperature.

6. The magnetic apparatus as recited in claim 1, wherein the heated or cooled magneto caloric effect material is a multiple-layers magneto caloric effect material with a plurality of curie temperatures and each layer of the multiple-layer magneto caloric effect material has a single curie temperature.

7. The magnetic apparatus as recited in claim 6, wherein each layer of the multiple-layer magneto caloric effect material is disposed sequentially according to the single curie temperature of each layer of the multiple-layers magneto caloric effect material.

8. The magnetic apparatus as recited in claim 1, wherein the magnetic material is circle-shaped, oval-shaped, rectangular-shaped, annular-shaped, or polygonal-shaped.

9. The magnetic apparatus as recited in claim 8, wherein the heated or cooled magneto caloric effect material is attached along with the magnetic material.

10. The magnetic apparatus as recited in claim 9, wherein the permanent magnetic element is disposed in the magnetic material.

11. The magnetic apparatus as recited in claim 10, wherein the heated or cooled magneto caloric effect material is a multiple-layers magneto caloric effect material with a plurality of curie temperatures and each layer of the multiple-layer magneto caloric effect material has a single curie temperature.

12. The magnetic apparatus as recited in claim 11, wherein each layer of the multiple-layer magneto caloric effect material is disposed sequentially according to the single curie temperature of each layer of the multiple-layers magneto caloric effect material.

13. The magnetic apparatus as recited in claim 1, wherein the permanent magnetic element has two magnetic poles, and the magnetic apparatus has three or six heated or cooled magneto caloric effect materials.

14. The magnetic apparatus as recited in claim 2, wherein the permanent magnetic element has two magnetic poles, and the magnetic apparatus has three or six heated or cooled magneto caloric effect materials.

15. The magnetic apparatus as recited in claim 1, wherein the permanent magnetic element has four magnetic poles, and the magnetic apparatus has six heated or cooled magneto caloric effect materials.

16. The magnetic apparatus as recited in claim 2, wherein the permanent magnetic element has four magnetic poles, and the magnetic apparatus has six heated or cooled magneto caloric effect materials.

17. The magnetic apparatus as recited in claim 2, wherein each of magnetic apparatus has the same amount of the heated or cooled magneto caloric effect material, and the permanent magnetic element to reduce the torque ripple

18. The magnetic apparatus as recited in claim 2, wherein each of magnetic apparatus has the same amount of the heated or cooled magneto caloric effect material and the permanent magnetic element, and each of the permanent magnetic element generates two magnetic poles.

19. The magnetic apparatus as recited in claim 1, wherein the permanent magnetic element is a permanent magnet, a permanent magnet array, or a Halbach magnet.

20. The magnetic apparatus as recited in claim 1, wherein the permanent magnetic element comprises at least one magnet and a magnetic material, an exciting coil surrounding the magnetic material with an exciting coil generating at least two magnetic poles.

21. The magnetic apparatus as recited in claim 20, wherein the exciting coil is a superconductor coil.

22. The magnetic apparatus as recited in claim 1, further comprising:
a magnetic force generating device disposed to heat or cool the heated or cooled magneto caloric effect material;
wherein the magnetic force generating device stores sensible heat released during a cooling process and releases sensible heat during a heating process.

23. The magnetic apparatus as recited in claim 22, wherein a thermal energy is generated during the cooling process or the heating process; and the thermal energy is transferred to the magnetic force generating device.

24. The magnetic apparatus as recited in claim 22, wherein the thermal energy is transferred from the magnetic force generating device to the magneto caloric effect material.

25. The magnetic apparatus as recited in claim 1, wherein the magnetic apparatus converts a low grade of heat into a mechanical power, and the low grade of heat is below 100 degree of Centigrade.

26. The magnetic apparatus as recited in claim 2, wherein the magnetic apparatus converts a low grade of heat into a mechanical power, and the low grade of heat is below 100 degree of Centigrade.

27. The magnetic apparatus as recited in claim 1, wherein the magnetic apparatus is connected to drive an electrical generator for generating electrical power.

28. The magnetic apparatus as recited in claim 2, wherein the magnetic apparatus is connected to drive an electrical generator for generating electrical power.

29. A magnetic system for outputting power, comprising:
at least one thermal energy switching unit; and
a magnetic apparatus, comprising:
a magnetic material;
at least one heated or cooled magneto caloric effect material disposed to the magnetic material and connected to the thermal energy switching unit;
a permanent magnetic element coupled to the magneto caloric effect material; and
at least a part of magnetic flux or magnetic flux paths formed to pass through the permanent magnetic element, the magneto caloric effect material, and the magnetic material;
wherein the permanent magnetic element or the magnetic material of the magnetic apparatus rotates when controlling the thermal energy switching unit to heat or to cool the heated or cooled magneto caloric effect material.

30. The magnetic system as recited in claim 29, wherein a mechanical torque is generated by the magnetic apparatus and at least two magnetic apparatus are coupled together to sum each mechanical torque.

31. The magnetic system as recited in claim 30, wherein a phase angle delay of each of the magnetic torque of the at least two magnetic apparatus is arranged to minimize a torque ripple and the phase angle delay is:
$$\frac{a circle angle ( 360 ° )}{an amount of the magnetic apparatus}$$

32. The magnetic system as recited in claim 31, wherein the circle angle is a whole step angle.

33. The magnetic system as recited in claim 29, wherein the magnetic material is a high permeability magnetic material or a yoke.

34. The magnetic system as recited in claim 29, wherein the heated or cooled magneto caloric effect material is a single-layer magneto caloric effect material with a single curie temperature.

35. The magnetic system as recited in claim 29, wherein the heated or cooled magneto caloric effect material is a multiple-layers magneto caloric effect material with a plurality of curie temperatures and each layer of the multiple-layer magneto caloric effect material has a single curie temperature.

36. The magnetic system as recited in claim 35, wherein each layer of the multiple-layer magneto caloric effect material is disposed sequentially according to the single curie temperature of each layer of the multiple-layers magneto caloric effect material.

37. The magnetic system as recited in claim 29, wherein the magnetic material is circle-shaped, oval-shaped, rectangular-shaped, annular-shaped, or polygonal-shaped.

38. The magnetic system as recited in claim 37, wherein the heated or cooled magneto caloric effect material is attached along with the magnetic material.

39. The magnetic system as recited in claim 38, wherein the permanent magnetic element is disposed in the magnetic material.

40. The magnetic system as recited in claim 39, wherein the magneto caloric effect material is a multiple-layers magneto caloric effect material with a plurality of curie temperatures.

41. The magnetic system as recited in claim 40, wherein each layer of the multiple-layer magneto caloric effect material has a single curie temperature.

42. The magnetic system as recited in claim 41, wherein each layer of the multiple-layer magneto caloric effect material is disposed sequentially according to the single curie temperature of each layer of the multiple-layers magneto caloric effect material.

43. The magnetic system as recited in claim 29, wherein the permanent magnetic element has two magnetic poles, and the magnetic apparatus has three or six heated or cooled magneto caloric effect materials.

44. The magnetic system as recited in claim 30, wherein the permanent magnetic element has two magnetic poles, and the magnetic apparatus has three or six heated or cooled magneto caloric effect materials.

45. The magnetic system as recited in claim 29, wherein the permanent magnetic element has four magnetic poles, and the magnetic apparatus has six heated or cooled magneto caloric effect materials.

46. The magnetic system as recited in claim 29, wherein the permanent magnetic element has four magnetic poles, and the magnetic apparatus has six heated or cooled magneto caloric effect materials.

47. The magnetic system as recited in claim 30, wherein each of magnetic apparatus has the same amount of the heated or cooled magneto caloric effect material, and the permanent magnetic element so as to achieve a lower torque ripple and output a smoother power.

48. The magnetic system as recited in claim 30, wherein each of magnetic apparatus has the same amount of the heated or cooled magneto caloric effect material and the permanent magnetic element, and each of the permanent magnetic element generates two magnetic poles.

49. The magnetic system as recited in claim 29, wherein the permanent magnetic element is a permanent magnet, a permanent magnet array, or a Halbach magnet.

50. The magnetic system as recited in claim 29, wherein the permanent magnetic element comprises at least one magnet and a magnetic material, an exciting coil surrounding the magnetic material with an exciting coil generating at least two magnetic poles.

51. The magnetic system as recited in claim 50, wherein the exciting coil is a superconductor coil.

52. The magnetic system as recited in claim 29, further comprising:
a magnetic force generating device disposed to heat or cool the heated or cooled magneto caloric effect material; wherein the magnetic force generating device is designed to store sensible heat released during a cooling process and release sensible heat during a heating process.

53. The magnetic system as recited in claim 29, wherein a thermal energy is generated during the cooling process or the heating process; and the thermal energy is transferred to the magnetic force generating device.

54. The magnetic system as recited in claim 53, wherein the thermal energy is transferred from the magnetic force generating device to the magneto caloric effect material.

55. The magnetic system as recited in claim 29, wherein the magnetic apparatus converts a low grade of heat into a mechanical power, and the low grade of heat is below 100 degree of Centigrade.

56. The magnetic system as recited in claim 30, wherein the magnetic apparatus converts a low grade of heat into a mechanical power, and the low grade of heat is below 100 degree of Centigrade.

57. The magnetic system as recited in claim 29, wherein the magnetic apparatus having the mechanical torque thus generating a mechanical power is connected to drive an electrical generator for electrical power generation.

58. The magnetic system as recited in claim 30, wherein the magnetic apparatus having the mechanical torque thus generating a mechanical power is connected to drive an electrical generator for electrical power generation.
